(19) United States
(12) Patent Application Publication
(10) Pub. No.: US 2008/0219596 A1
(43) Pub. Date: Sep. 11, 2008

(54) METHOD, APPARATUS, AND PROGRAM FOR SEARCHING FOR IMAGES

(75) Inventors: Shuichi Shiitani, Kawasaki (JP); Takayuki Baba, Kawasaki (JP); Susumu Endo, Kawasaki (JP); Yusuke Uehara, Kawasaki (JP); Shigemi Nagata, Kawasaki (JP); Daiki Masumoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/036,637

(22) Filed: Feb. 25, 2008

(30) Foreign Application Priority Data
Mar. 5, 2007 (JP) 2007-054068

(51) Int. Cl. G06K 9/54

(52) U.S. Cl. 382/306

(57) ABSTRACT

According to an aspect of an embodiment, a method for searching a set of image data from a database which contains a plurality of sets of image data, at least one of the sets of the image data being associated with text data, the method comprising the steps of: obtaining keyword information; detecting first set of image data in said database associated with text data corresponding to said keyword information; and detecting second set of image data in said database on the basis of the feature of an image represented by said first set of image data.

### TECHNICAL FIELD

This embodiment relates to a program, a method, and an apparatus for searching for images.

### SUMMARY

According to an aspect of an embodiment, a method for searching a set of image data from a database which contains a plurality of sets of image data, at least one of the sets of the image data being associated with text data, the method comprising the steps of: obtaining keyword information; detecting first set of image data in said database associated with text data corresponding to said keyword information; and detecting second set of image data in said database on the basis of the similarity of the feature of an image represented by said first set of image data.

### BRIEF DESCRIPTION OF THE DRAWINGS

FIG. 1 is a block diagram of a function of image search apparatus according to an embodiment;

FIG. 2 is a block diagram of hardware of image search apparatus of the aspect of the embodiment;

FIG. 3 shows an image database in the aspect of the embodiment;

FIG. 4 is a flowchart of search processing in the aspect of the embodiment;

FIG. 5 illustrates an example of feature determination of image information;

FIG. 6 is a flowchart of processing for detecting similar image information;

FIG. 7 illustrates determination of features for detecting similar images;

FIG. 8 shows an updated image database;

FIG. 9 shows a first display example of image information resulting from the detection;

FIG. 10 shows a second display example of image information resulting from the detection;

FIG. 11 is a flowchart of processing for determining the order of displaying the image information, which is a search result;

FIG. 12 shows a third display example of image information resulting from the detection;

FIG. 13 shows a step function;

FIG. 14 shows a sigmoid function;

FIG. 15 is a flowchart of another scheme for the feature detection processing executed by the controller in step S103 shown in FIG. 4;

FIG. 16 is a block diagram showing an example of the configuration of a system that includes multiple databases;

FIG. 17 shows an example of the structure of data stored in the video-information storage module; and

FIG. 18 is a block diagram showing an example of a hardware structure for the system shown in FIG. 16.

### DESCRIPTION OF THE PREFERRED EMBODIMENT

An aspect of this embodiment relates to a program, a method, and an apparatus for searching for images.

With an increase in the storage capacities of storage devices for storing image information, opportunities for search processing of image information are increasing. Two methods are generally available for the search processing of image information. In a first method, images are pre-given text information describing the respective images and the text information is searched using a keyword. In a second method, sketches or image information is used as search queries and similarities relative to image information stored in a database are calculated to search for highly similar images.

The first method requires that appropriate text information be pre-given to individual images. The first method, however, has some problems. Specifically, a cost is required to affix text information, affixing keywords corresponding to search intensions of all users in advance is impossible, and search cannot be performed using a keyword unless the same keyword is affixed to a desired image. Search for images on the Internet solves the problem of requiring a cost for affixing keywords, by associating image information and text information on the same web page with each other. However, the text information does not necessarily explain the image information associated therewith, and the problem of the association between the keywords and the search intensions still remains. The second method has a problem of having to prepare sketches or image information that serves as search queries. When the user draws the sketches that serve as search queries, there is a problem in that different search results are obtained depending on the user's technique for drawing the sketches. It is an object of the aspect of the embodiment to provide an apparatus that can search for image information to which no keyword is affixed, by using a keyword.

The aspect of the embodiment allows even image information to which no text information is given to be searched for using a keyword. As a result, the user can easily find desired image information.

The aspect of the embodiment will be described below with reference to the accompanying drawings.

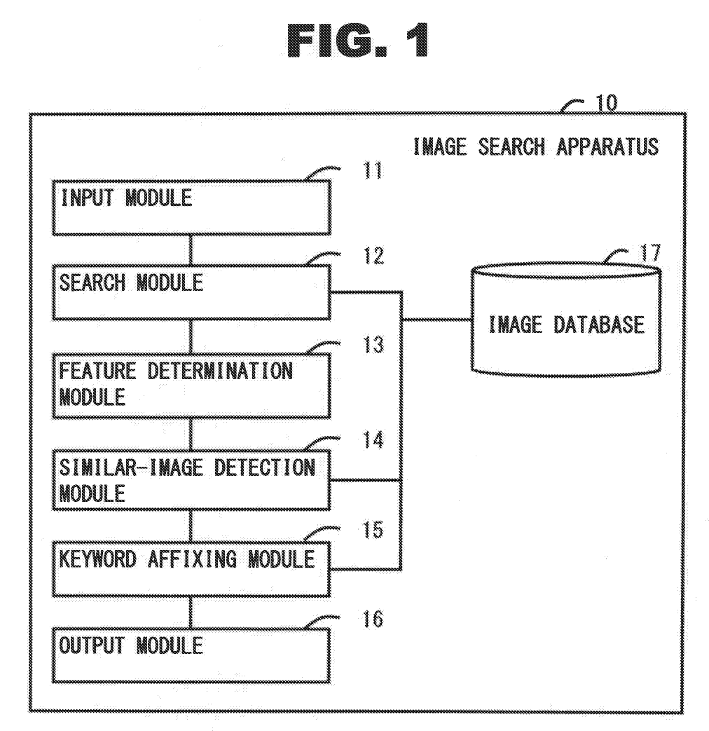

FIG. 1 is a functional block diagram of an image search apparatus 10 according to the aspect of the embodiment.

The image search apparatus 10 of the aspect of the embodiment includes an input module 11, a search module 12, a feature determination module 13, a similar-image detection module 14, a keyword affixing module 15, an output module 16, and an image database 17.

The input module 11 obtains search query word information for searching for image information. For example, when a user enters search query word information with a keyboard or the like, the input module 11 obtains the input search query word information.

The search module 12 searches the image database 17 for image information corresponding to the search query word information. As a result of the search, the search module 12 obtains a list of image information corresponding to the search query word information.

The image database 17 is a database in which image information is stored. In the image database 17, the image information and text information stating description regarding the image information are stored in association with each other. A pair of image information and text information which are stored in the image database 17 will herein be referred to as a “data record”. The text information of the data record does not necessarily have to state all description regarding the image information. In addition, the text information associated with the image information does not necessarily have to be provided in the data record.

The feature determination module 13 determines features of the image information. The image information is comprised set of image data. For example, the image data is pixel, an area of the image. The feature of an image is represented by the set of image data. The features of the image information are values that the image detection module 14 uses to detect similar images and are unique values for each piece of image information which are determined by a predetermined computation from the image information. Examples of the features of the image information include color histogram features representing a ratio of color in an image and color layout features representing the layout of color in an image. The feature determination module 13 holds the determined features of the image information.

The similar-image detection module 14 detects, from the image database 17, image information that is similar to the image information obtained by the search module 12. More specifically, the similar-image detection module 14 computes similarities between the features of the image information read from the image database 17 and the features of the image information obtained by the search module 12 to detect highly similar image information in the image database 17. The similar-image detection module 14 reads image information stored in the image database 17 piece by piece. Image information to be read may be image information other than the image information obtained by the search module 12 as a search result, or may be all image information with which no text information is associated. One example of a method for the similarity calculation is to determine the similarity from an average of Euclidean distances between the features of image information in an image list obtained by the search module 12 and the features of image information in the image database 17. Examples of a method for extracting the highly similar image information in the image database 17 include a method for extracting all image informatics having similarities greater than or equal to a predetermined value by using the results of similarities computed for respective pieces of image information and a method for extracting a predetermined number of pieces of image information in descending order of similarity.

The keyword affixing module 15 associates the search query word information obtained by the input module 11 with the image information extracted by the similar-image detection module 14 and stores the associated information in the image database 17. When text information that is already associated with image information is stored in the image database 17, the keyword affixing module 15 affixes the search query word information obtained by the input module 11 to the text information and stores the resulting information in the image database 17, without deleting the text information.

The output module 16 outputs the search result. For example, the output module 16 displays a group of image information on a display screen. For display of the group of image information, the output module 16 changes the display sequence of the image information in accordance with a display condition desired by the user.

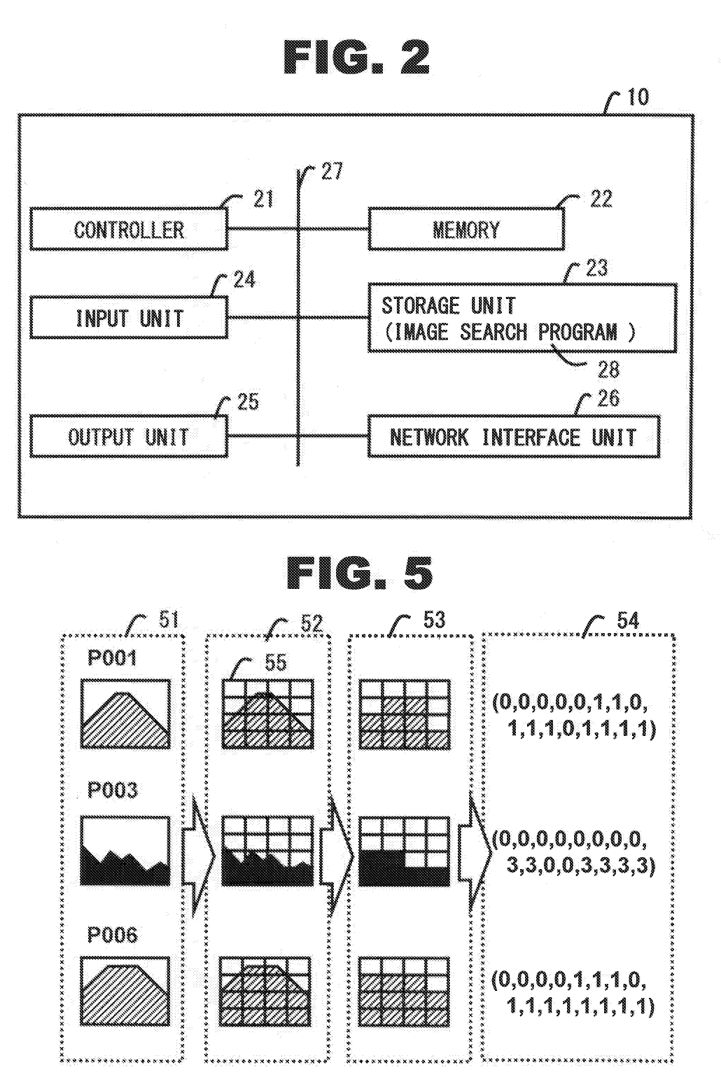

FIG. 2 is a block diagram of hardware of image search apparatus of the aspect of the embodiment. The image search apparatus 10 includes a controller 21, a memory 22, a storage unit 23, an input unit 24, an output unit 25, and a network interface unit 26, which are connected to a bus 27.

The controller 21 controls the entire image search apparatus 10 and is, for example, a central processing unit (CPU). The controller 21 executes an image search program 28 loaded in the memory 22. The image search program 28 causes the control 21 to function as the input module 11, the search module 12, the feature determination module 13, the similar-image detection module 14, the keyword affixing module 15, and the output module 16.

The memory 22 is a storage area into which the image search program 28 stored in the storage unit 23 is to be loaded. The memory 22 is a storage area in which various computation results generated while the controller 21 executes the image search program 28. The memory 22 is, for example, a random access memory (RAM).

The input unit 24 receives search query word information from the user. The input unit 24 includes, for example, a keyboard, a mouse, and a touch panel.

The output unit 25 outputs a search result of image information. The output unit 25 includes, for example, a display (display device).

The storage unit 23 stores the image search program 28 and the image database 17. The storage unit 23 includes, for example, a hard disk device.

The network interface unit 26 is connected to a network, such as the Internet or a local area network (LAN), to allow data to be transmitted/received through the network. Thus, the image search apparatus 10 may be connected to another apparatus having an input unit, an output unit, a memory, and a storage unit, via the network interface unit 26. The image search apparatus 10 can also download, for example, the image search program 28 received via the network interface unit 26 or recorded on a storage medium.

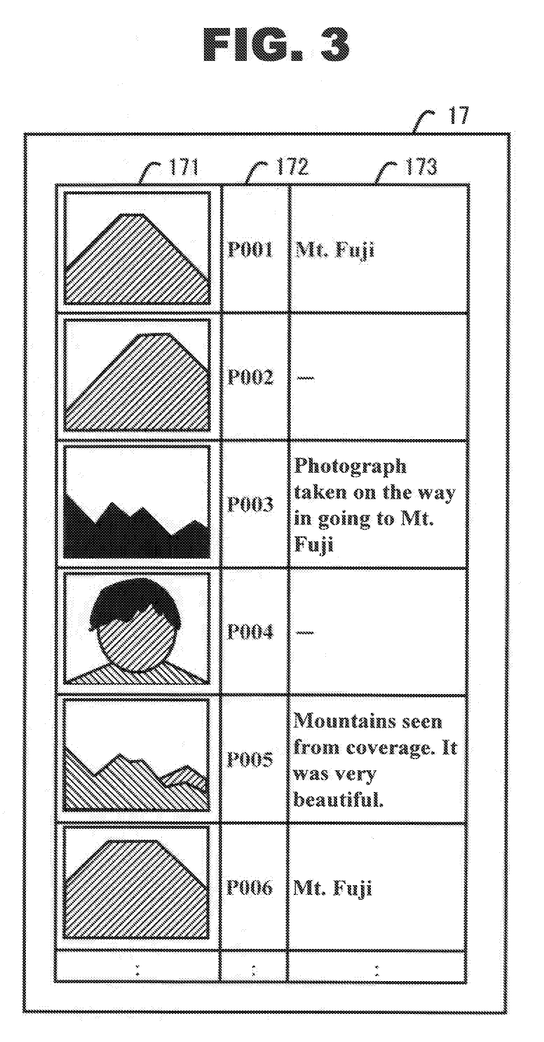

FIG. 3 is a schematic diagram of the image database 17 in the aspect of the embodiment. Image information 171 is stored in the image database 17. Text information 173 is stored in the image database 17 in association with the image information 171. In the image database 17 in the aspect of the embodiment, the image information 171, image file name 172, and the text information 173 are stored in association with each other. A pair of an image file name 172 and text information 173 corresponding to one piece of image information 171 is referred to as a “data record”.

The image database 17 also has data records in which text information 173 is not affixed to the image information 171. The text information 173 may have a predetermined format or may be a format that can be arbitrarily input by the user. A known method can be used to store the image information 171, the image file names 172, and the text information 173 in the image database 17 in association with each other.

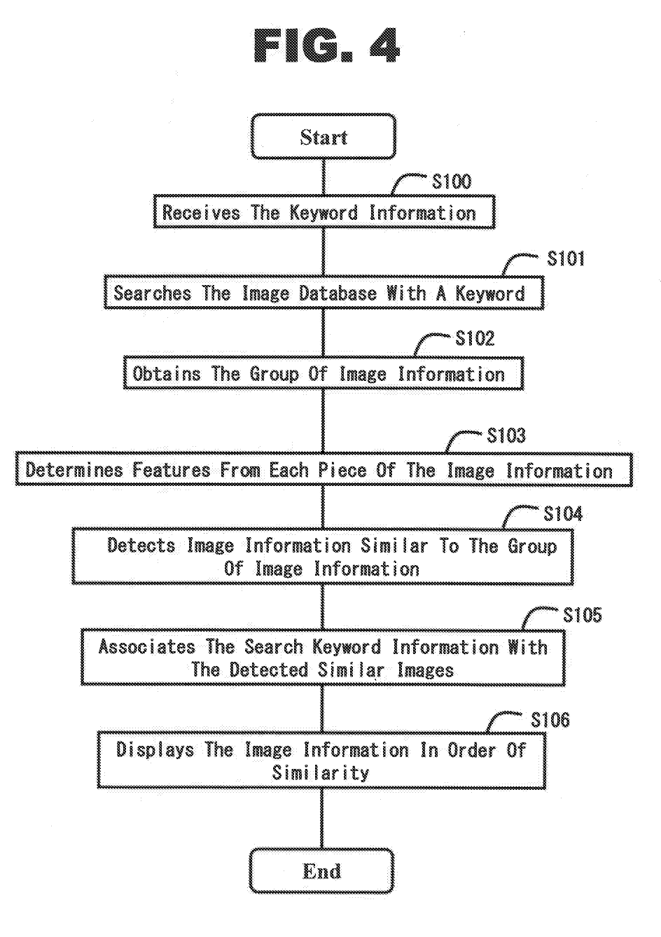

Search processing in the aspect of the embodiment will now be described. FIG. 4 is a flowchart of search processing in the aspect of the embodiment. In the aspect of the embodiment, the image information 171 is pre-stored in the image database 17, and the text information 173 is not affixed to some pieces of the image information 171.

The user enters search query word information to the image search apparatus 10. In step S100, the controller 21 in the image search apparatus 10 receives the search query word information input to the input unit 24. For example, it is assumed that the user entered search query word information “Mt. Fuji” to the input unit 24.

In step S101, the controller 21 searches the image database 17 with a keyword. More specifically, the controller 21 detects text information 173 that is stored in the image database 17 and that matches the search query word information received in step S100. The controller 21 detects data records having text information 173 that contains a character string “Mt. Fuji”. In the image database 17 shown in FIG. 3, the image file names 172 of data records having text information 173 that contains the character string “Mt. Fuji” are P001, P003, and P006.

In step S102, the controller 21 obtains the group of image information 171 contained in the data records detected in step S101. Thus, the controller 21 obtains the group of image information 171 corresponding to the image file names 172 “P001”, “P003”, and “P006”.

In step S103, the controller 21 then determines features from each piece of the image information 171, which is the search result. The features can be determined using a scheme for determining various types of features, such as color histogram features representing a ratio of color contained in image information, color layout features representing color for individual portions in image information, and edge distribution features representing the boundary position of an object in image information. A combination of the feature determination schemes may be used as the determination scheme to determine the features.

FIG. 5 illustrates an example of the feature determination of the image information. In the aspect of the embodiment, a description will be given of a case in which one feature-determination method using color layout features.

A first state 51 in FIG. 5 shows the image information 171 obtained in step S102, the image file names 172 of the image information 171 being P001, P003, and P006. The controller 21 divides each piece of the image information 171 obtained in step S102 into 16 (4×4) areas 55, the image file names 172 thereof being P001, P003, and P006. A second state 52 in FIG. 5 shows the state in which the controller 21 divides each piece of the image information 171 into the areas 55.

As shown in the second state 52, the controller 21 obtains color information having a largest amount of color in each area 55 of each piece of image information 171. A third state 53 in FIG. 5 shows the state in which the controller 21 obtains color information having the largest amount of color in each area 55 in each piece of image information 171. The amount of color in each area 55 is compared based on, for example, the number of pixels. The controller 21 obtains color layout features by sequentially arranging the color data of the areas 55 from the upper left in the image information 171. A fourth state 54 in FIG. 5 shows the color layout features obtained by the controller 21.

For the values of color data in FIG. 5, white is expressed by “0”, light gray (shown by oblique lines from the upper right to the lower left) is expressed by “1”, dark gray (shown by oblique lines from the upper left to the lower right) is expressed by “2”, and black is expressed by “3”. Thus, the features of the image file name 172 “P001” are (0, 0, 0, 0, 0, 1, 1, 0, 1, 1, 1, 0, 1, 1, 1, 1), the features of the image file name 172 “P003” are (0, 0, 0, 0, 0, 0, 0, 0, 3, 3, 0, 0, 3, 3, 3, 3), and the features of the image file name 172 “P006” are (0, 0, 0, 0, 1, 1, 1, 0, 1, 1, 1, 1, 1, 1, 1, 1).

The controller 21 temporarily stores the determined features in association with the corresponding pieces of image information 171, in order to use the features for determining similarities.

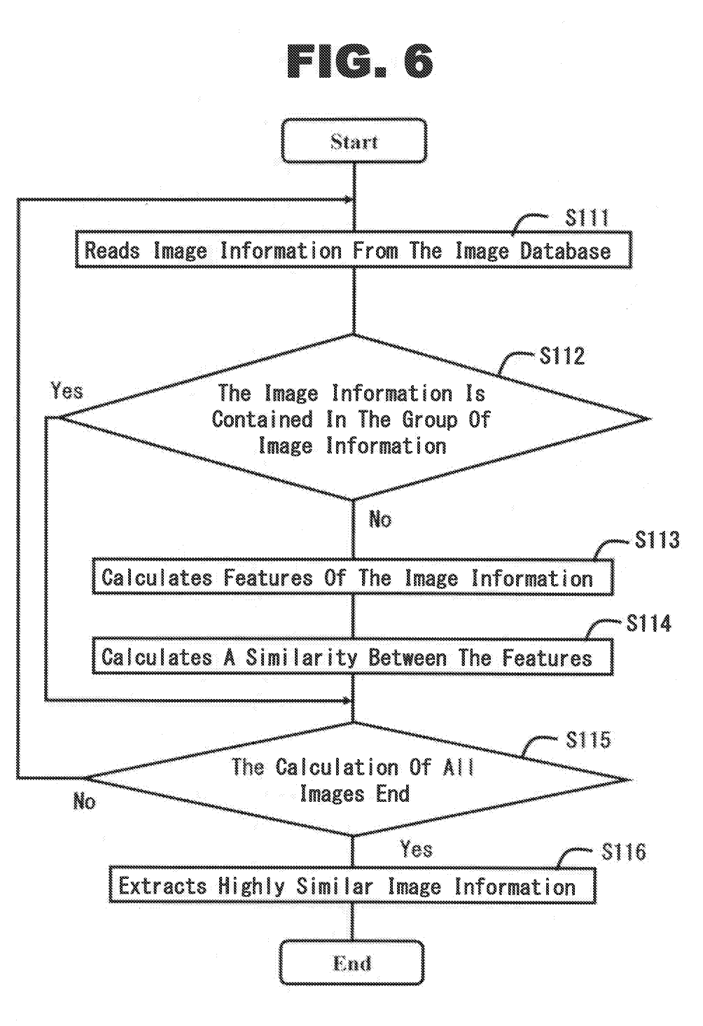

Next, in step S104, the controller 21 detects, from the image database 17, image information similar to the group of image information obtained in step S102. FIG. 6 illustrates the processing for detecting similar images.

FIG. 6 is a flowchart of the processing for detecting similar image information. In step S111, the controller 21 reads, from the image database 17, image information to be subjected to similarity determination.

In step S112, the controller 21 determines whether or not the image information read in step S111 is contained in the group of image information obtained in step S102. When the image information read in step S111 is contained in the group of image information obtained in step S102 (i.e., Yes in step S112), the image information has already been detected as a search result. Thus, the controller 21 performs processing for detecting next image information in the image database 17. On the other hand, when the image information read in step S111 is not contained in the group of image information obtained in step S102 (i.e., No in step S112), in step S113, the controller 21 calculates features of the image information read in step S111.

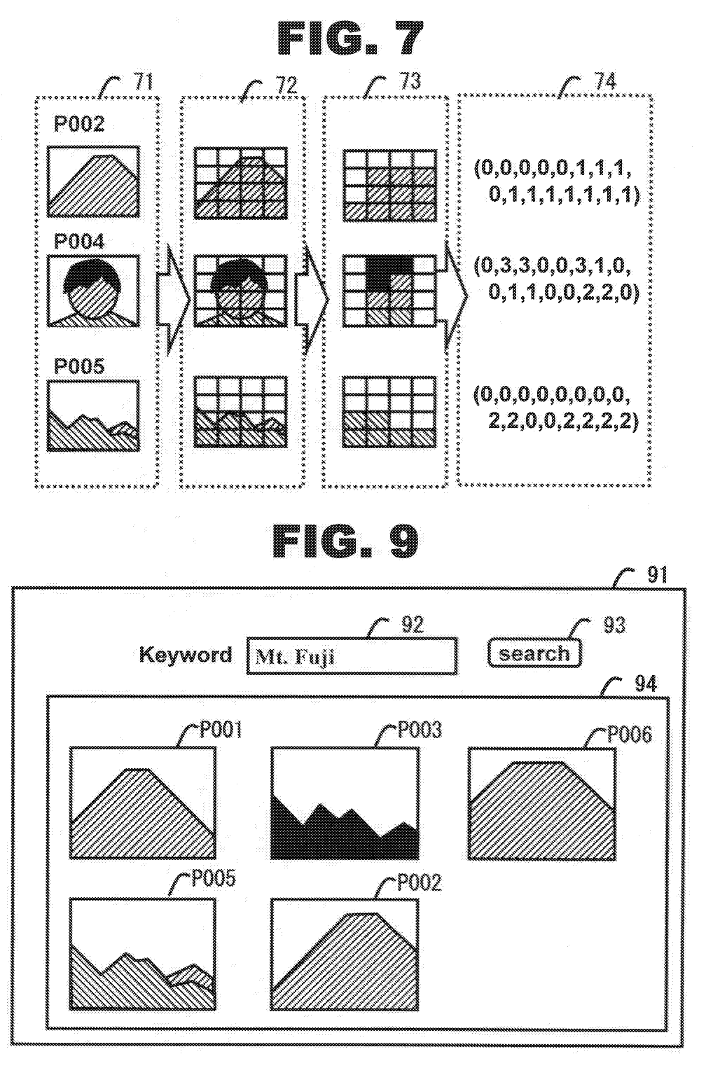

FIG. 7 illustrates determination of features for detecting similar images. In the aspect of the embodiment, a description will be given of a case using one feature-determination method using color layout features, as in FIG. 5. Although the flowchart in FIG. 6 shows a case in which the controller 21 repeatedly performs feature determination processing on one piece of image information, FIG. 7 shows three pieces of image information for simplicity of description. In the processing in steps S111 to S113, the controller 21 obtains the image information 171 of the data records that were not detected in the image-information search processing performed in step S101 using the search query word information, that is, the image information 171 with the image file names 172 “P001”, “P004”, and “P005”, and also determines features of the individual pieces of the image information 171. A state 71 in FIG. 7 shows the image information 171 obtained by the controller 21. A state 72 in FIG. 7 represents the state in which the controller 21 divides the area of each piece of image information 171 into 16 areas. A state 73 in FIG. 7 represents a state in which the controller 21 obtains color information having a largest amount of color out of colors in each of the 16 areas in the image information which were divided in the state 72. A state 74 in FIG. 7 shows the color layout features determined by the controller 21.

For the values of color data in FIG. 7, white is expressed by “0”, light gray (shown by oblique lines from the upper right to the lower left) is expressed by “1”, dark gray (shown by oblique lines from the upper left to the lower right) is expressed by “2”, and black is expressed by “3”. In this case, the features of the image file name 172 “P002” are (0, 0, 0, 0, 0, 1, 1, 1, 0, 1, 1, 1, 1, 1, 1, 1), the features of the image file name 172 “P004” are (0, 3, 3, 0, 0, 3, 1, 0, 0, 1, 1, 0, 0, 2, 2, 0), and the features of the image file name 172 “P005” are (0, 0, 0, 0, 0, 0, 0, 0, 2, 2, 0, 0, 2, 2, 2, 2).

Next, in step S114, the controller 21 calculates a similarity between the features determined in step S113 and the features (obtained in step S103) of the group of image information detected by the search using the search query word information.

Through the repeated processing in steps S111 to S115, the controller 21 calculates a similarity between three pieces of image information with the image file names 172 “P001”, “P003”, and “P006” and the image information 171 with the image file name 172 “P002”, a similarity between three pieces of image information with the image file names 172 “P001”, “P003”, and “P006” and the image information 171 with the image file name 172 “P004”, and a similarity between three pieces of image information with the image file names 172 “P001”, “P003”, and “P006” and the image information 171 with the image file name 172 “P005”.

Various methods are possible to calculate the similarity of one piece of image information relative to multiple pieces of image information. In the aspect of the embodiment, similarities relative to individual pieces of image information are determined and an average value of the determined similarities is used as the similarity of one piece of image information relative to multiple pieces of image information.

Euclidean distances are used to calculate similarities relative to image information. A Euclidean distance expresses the distance of a vector between two pieces of image information, and becomes smaller as the similarity increases. A total sum of the distances of vectors of the 16 divided areas in image information may be obtained in the aspect of the embodiment. For example, a vector distance between the image information 171 with the image file name 172 “P001” and the image information 171 with the image file name 172 “P002” is determined from expression (1). Square root “A” is the similarity between “P001” and “P002”.

$$A = {( 0 - 0 )}^{2} + {( 0 - 0 )}^{2} + {( 0 - 0 )}^{2} + {( 0 - 0 )}^{2} + {( 0 - 0 )}^{2} + {( 1 - 1 )}^{2} + {( 1 - 1 )}^{2} + {( 1 - 0 )}^{2} + {( 0 - 1 )}^{2} + {( 1 - 1 )}^{2} + {( 1 - 1 )}^{2} + {( 1 - 0 )}^{2} + {( 1 - 1 )}^{2} + {( 1 - 1 )}^{2} + {( 1 - 1 )}^{2} + {( 1 - 1 )}^{2} \qquad expression ( 1 )$$

The similarity of the image information 171 with the image file name 172 “P002” relative to the three pieces of image information 171 with the image file names 172 “P001”, “P003”, and “P006” is expressed by an average value of the similarity between the image information 171 with the image file name 172 “P001” and the image information 171 with the image file name 172 “P002”, the similarity between the image information 171 with the image file name 172 “P003” and the image information 171 with the image file name 172 “P002”, and the similarity between the image information 171 with the image file name 172 “P006” and the image information 171 with the image file name 172 “P002”. The similarity between the image information 171 with the image file name 172 “P001” and the image information 171 with the image file name 172 “P002” is 1.7, the similarity between the image information 171 with the image file name 172 “P003” and the image information 171 with the image file name 172 “P002” is 5.8, and the similarity between the image information 171 with the image file name 172 “P006” and the image information 171 with the image file name 172 “P002” is 1.7. Thus, the average value of the similarity between the image information 171 with the image file name 172 “P001” and the image information 171 with the image file name 172 “P002”, the similarity between the image information 171 with the image file name 172 “P003” and the image information 171 with the image file name 172 “P002”, and the similarity between the image information 171 with the image file name 172 “P006” and the image information 171 with the image file name 172 “P002” is 3.1. Thus, the similarity of the image information 171 with the image file name 172 “P002” relative to the three pieces of image information 171 with the image file names 172 “P001”, “P003”, and “P006” is 3.1. Calculation is similarly performed on the image information 171 with the image file names 172 “P004” and “P005”. Consequently, the similarity of the image information 171 with the image file name 172 “P004” relative to the three image information 171 with the image file names 172 “P001”, “P003”, and “P006” is 6.2, and the similarity of the image information 171 with the image file name 172 “P005” relative to the three image information 171 with the image file names 172 “P001”, “P003”, and “P006” is 2.9.

A description will now be given of another scheme for the similarity determination executed by the controller 21 in step S114. The similarity average value of the image information 171 with the image file name 172 “P005”, the average value being the result of the similarity determination in step S114, is smaller than the similarity average value of the image information 171 with the image file name 172 “P002”. Thus, the controller 21 determines that the image information 171 with the image file name 172 “P005” is more similar to the each piece of the image information detected by the keyword searching than the image information 171 with the image file name 172 “P002”. The reason why the controller 21 determines that the image information 171 with the image file name 172 “P005” is more similar than the image information 171 with the image file name 172 “P002” is that the image information 171 with the image file name 172 “P005” is generally similar to the image information 171 with the image file names 172 “P001” and “P006”, the image information 171 with the image file name 172 “P005” is significantly similar to the image information 171 with the image file name 172 “P003”, and on the other hand, the image information 171 with the image file name 172 “P002” is greatly different from the image information 171 with the image file name 172 “P003”.

A data record in which image information 171 and text information 173 are not associated with each other may exist. For example, although the image information 171 with the image file name “P003” is associated with the text information 173 containing “Mt. Fuji”, the image information 171 with the image file name “P003” may be image information other than image information of Mt. Fuji. Thus, the image information detected using the search query word information may contain image information that is not desired by the user.

Accordingly, after determining the similarities relative to the individual pieces of image information in step S114, the controller 21 obtains only similarities that exceed a predetermined threshold.

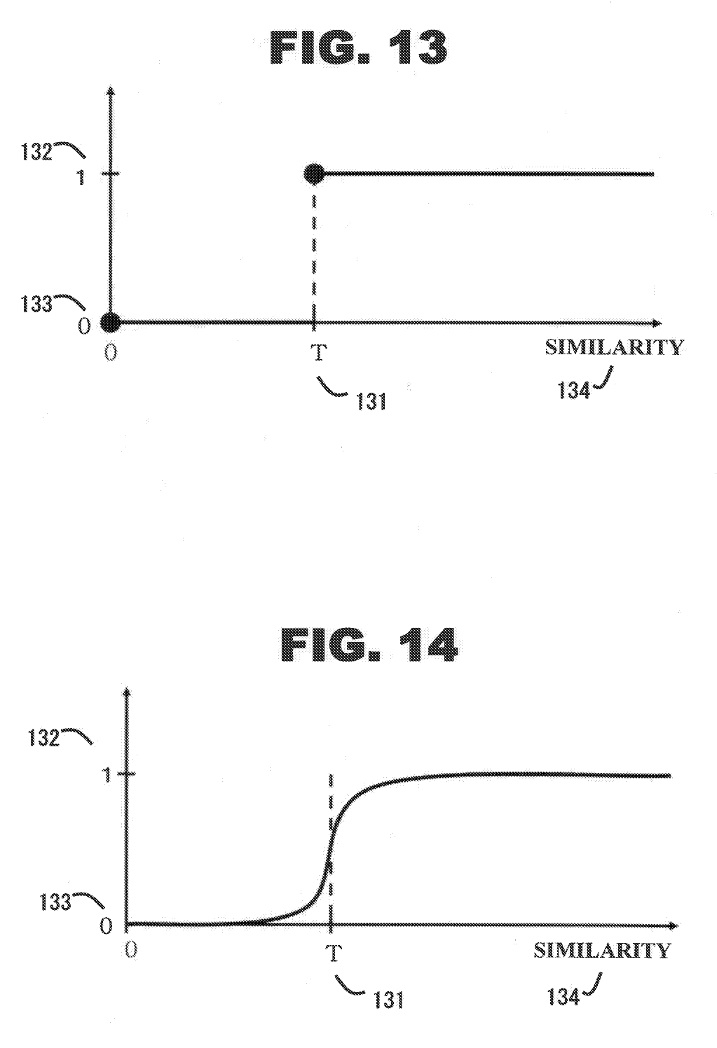

FIG. 13 shows a step function. When a similarity 134 is greater than or equal to “T” (denoted by reference numeral 131), the controller 21 executes processing for multiplying the similarity by “1” (denoted by reference numeral 132), in accordance with the step function shown in FIG. 13. When the similarity 134 is less than “T” 131, the controller 21 executes processing for multiplying the similarity by “0” (denoted by reference numeral 133).

For example, for “T”=3.0, with respect to the similarities between three pieces of image information with the image file names P001, P003, and P006 and the image information 171 with the image file name P002, the similarity between the image information 171 with the image file name P001 and the image information 171 with the image file name P002 is 0, the image information 171 with the image file name P003 and the image information 171 with the image file name P002 is 5.8, and the image information 171 with the image file name P006 and the image information 171 with the image file name P002 is 0. As a result, the average value of the similarities between the three pieces of image information 171 with the image file names P001, P003, and P006 and the image information 171 with the image file name P002 is 1.9.

On the other hand, with respect to the similarities between three pieces of image information 171 with the image file names P001, P003, and P006 and the image information 171 with the image file name P005, the similarity between the image information 171 with the image file names P001 and the image information 171 with the image file name P005 is 3.0, the similarity between the image information 171 with the image file name P003 and the image information 171 with the image file name P005 is 0, and the similarity between the image information 171 with the image file name P006 and the image information 171 with the image file name P005 is 3.3. As a result, the average value of the similarities between the three pieces of image information 171 with the image file names P001, P003, and P006 and the image information 171 with the image file name P005 is 2.1. Thus, it is determined that, of the image information 171 with the image file names P001, P003, and P006 detected using the search query word information “Mt. Fuji”, the image information 171 with the image file name P002 is similar to two pieces of image information 171 with the image file names P001 and P006 and the image information 171 with the image file name P005 is similar to only image information 171 with the image file name P003.

Thus, since the controller 21 determines similarities between image information and then multiplies the similarities in accordance with the step function, the average value of the similarities becomes large when a large number of highly similar images exist. As a result, it is possible to perform similar-image search with accuracy. The function used for the search is not limited to the step function shown in FIG. 13, and the use of a preset weight function can provide the same advantages. One example of the weighting function is a sigmoid function shown in FIG. 14.

Next, in step S115, the controller 21 determines whether or not the reading of all images is completed. When the reading of all images is not completed (No in step S115), the controller 21 reads a next image from the image database 17. On the other hand, when the reading of all images is completed (Yes in step S115), the controller 21 extracts highly similar image information in step S116. For example, the controller 21 extracts, as highly similar image information, only images whose similarities determined in step S114 for each piece of image information exceed a predetermined threshold. The number of pieces of image information to be extracted as similar images may be predetermined, so that only a predetermined number of pieces of image information can foe displayed out of highly similar image information. The threshold in the aspect of the embodiment is assumed to be 5.0. The image information 171 having a similarly average value of 5.0 or less is the image information 171 with the image file names P002 and P005. Thus, the controller 21 extracts, as highly similar image information, the image information 171 with the image file names P002 and P005.

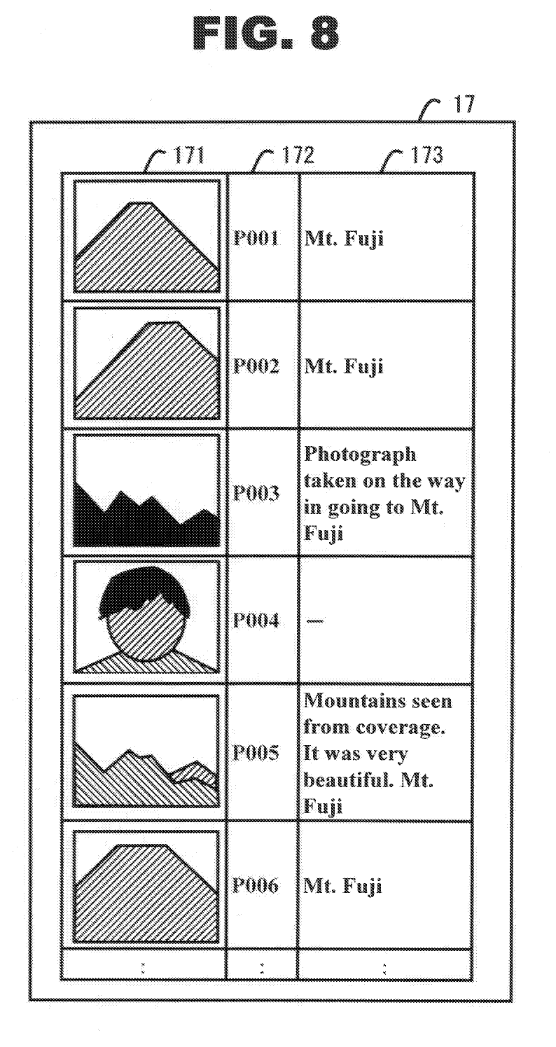

The search processing of the aspect of the embodiment will now be described with reference back to the flowchart shown in FIG. 4. In step S105, the controller 21 associates the search query word information with the detected similar images. More specifically, the controller 21 causes the search query word information to be stored in areas in the text information 173 of the data records containing the detected similar images. When text information is already stored in the text information 173 of the data records, the controller 21 additionally stores the search query word information to the already-stored text information. FIG. 8 shows the updated image database 17. With this arrangement, appropriate text information can be added to the image information, as the database 17 is repeatedly searched.

Lastly, in step S106, the controller 21 displays the image information. FIG. 9 shows a first display example of the image information resulting from the detection. A display area 91 on a screen has an area 92 for displaying the input search query word information, an area 93 for displaying a switch for giving an instruction for starting the execution of the search processing, and an area 94 for displaying the image information, which is the search result. The area 94 for displaying the image information of the search result displays the image information with the image file names P001, P003, and P006 detected using the search query word information “Mt. Fuji” as well as the image information 171 with the image file names P002 and P005 which is similar to the image information 171 with the image file names P001, P003, and P006. In FIG. 9, the controller 21 displays the image information 171 in order of similarity. In the aspect of the embodiment, image information that matches the search query word information is displayed in order of file name. The sort order is not limited to the order of file name and may be another order. The order of image file names 172 may be, for example, an ascending alphabetical order or ascending numerical order. The controller 21 displays, in a descending order of similarity, image information having similarity values that were determined by the similar-image information search as exceeding the predetermined threshold.

With the processing described above, when the user enters the search query word information “Mt. Fuji”, the controller 21 can detect even image information with which the search query word information “Mt. Fuji” has not been associated.

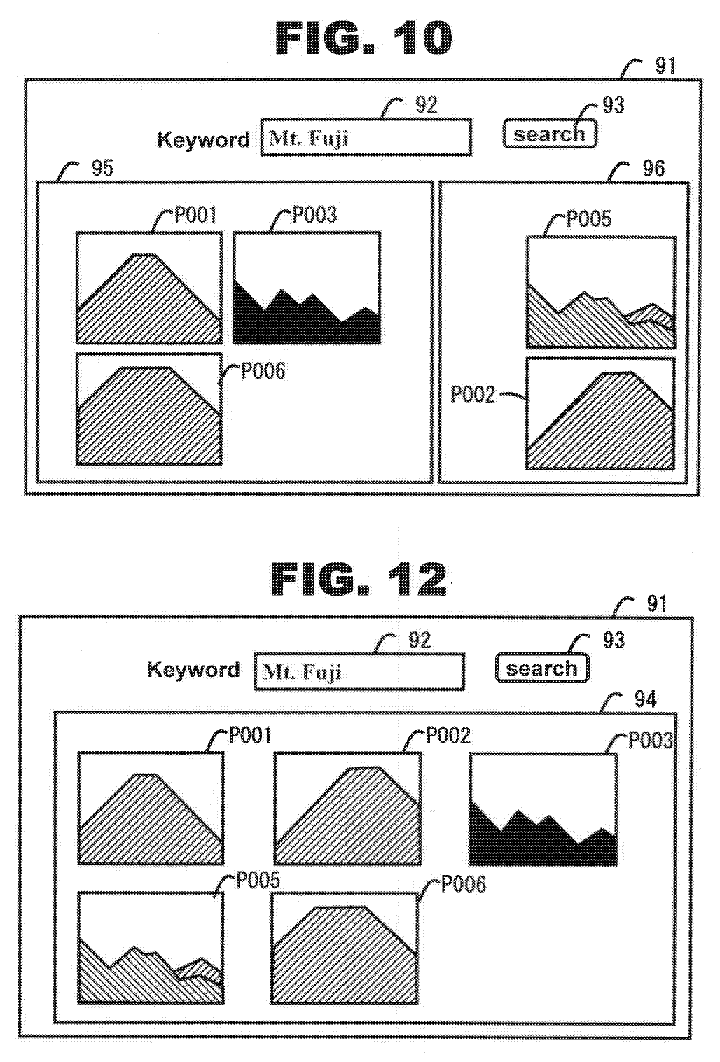

In step S106, the controller 21 can also display the image information by another display method. FIG. 10 shows a second display example of the image information resulting from the detection. A display area 91 on the screen has an area 92 for displaying the input search query word information, an area 93 for displaying a switch for giving an instruction for starting the execution of the search processing, a first area 95 for displaying the image information result from the search processing performed in step S101 using the search query word information, and a second area 96 for displaying the image information resulting from the similar-image search processing performed in step S116.

The first area 95 for displaying the image information, which is the search result, displays the image information 171 with the image file names P001, P003, and P006 detected using the search query word information “Mt. Fuji”. The image information 171 that matches the search query word information is displayed in the first area 95 in order of image file name 172. The sort order is not limited to the order of file names and may be another order.

The second area 96 for displaying the image information, which is the search result, displays the image information with the image file names P002 and P005 which is similar to the image information 171 with the image file names P001, P003, and P006. In FIG. 10, the controller 21 displays the image information in the second area 96 in order of similarity. That is, the controller 21 displays, in a descending order of similarity, image information having similarity values that were determined by the similar-image information search as exceeding the predetermined threshold.

The first area 95 for displaying the image information resulting from the search processing using the search query word information and the second area 96 for displaying the image information resulting from the similar-image search processing in step S116 are separately displayed as shown in FIG. 10. This arrangement allows the user to easily recognize whether an image of interest was searched using a keyword or searched using the similarity calculation.

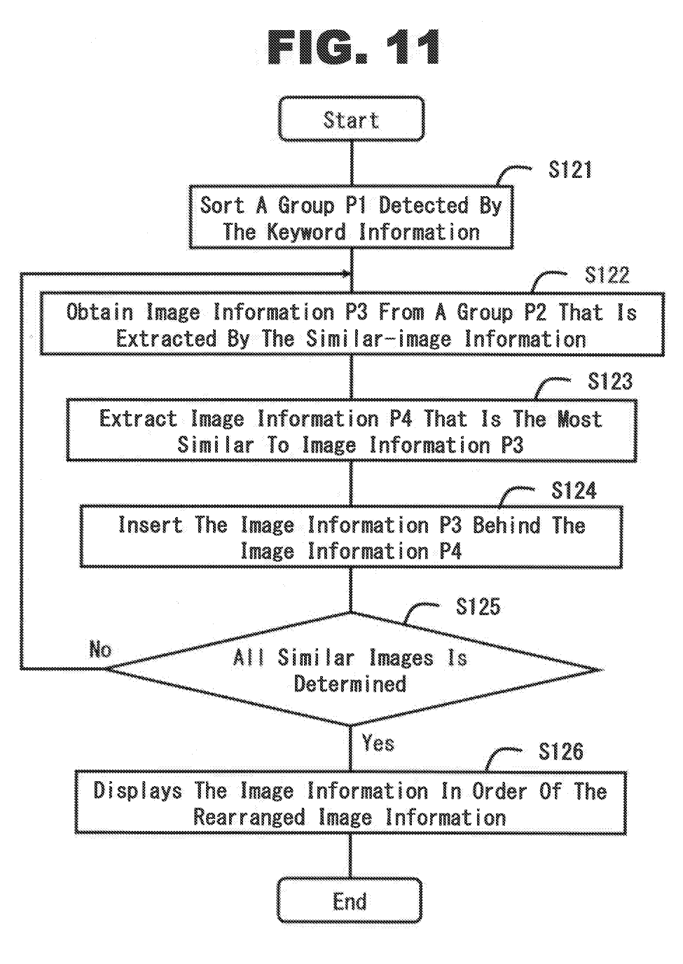

In addition, in step S106, the controller 21 can also display the search result of the image information by another display method. FIG. 11 is a flowchart of processing for determining the order of displaying the image information, which is the search result.

In step S121, the controller 21 sorts and arranges a group P1 of image information (including the image information 171 with the image file names P001, P003, and P006 shown in FIG. 3) detected using the search query word information. The sort is performed based on the match rate of search query word information, the number of accesses to image information, or another criterion. In the aspect of the embodiment, the image information group P1 is assumed to be sorted and arranged in order of the image information 171 with the image file names P001, P003, and P006.

Next, in step S122, the controller 21 obtains one piece of image information P3 from an image information group P2 that is extracted by the similar-image information search and that is highly similar to the image information group P1 detected using the search query word information. In the aspect of the embodiment, the controller 21 obtains the image information 171 with the image file name P002 as one piece of image information P3.

In step S123, the controller 21 extracts, of the image information group P1 detected using the search query word information, image information P4 that is the most similar to image information P3 obtained in step S122. The image information 171 with the image file name P001 is selected as the image information P4 that is the most similar to the image information 171 with the image file name P002 which is the image information P3.

In step S124, the controller 21 inserts the image information P3 behind the image information P4. That is, in the aspect of the embodiment, the controller 21 inserts the image information 171 with the image file name P002 behind the image information 171 with the image file name P001. Since the image information with the image file name P005 is the most similar to the image information 171 with the image file name P003, the controller 21 inserts the image information 171 with the image file name P005 behind the image information 171 with the image file name P003.

When the insertion with respect to all similar images is not determined (No in step S125), the controller 21 executes rearrangement processing for the next similar image information in step S122. On the other hand, when the insertion with respect to all similar images is determined (Yes in step S125), the controller 21 displays the image information in order of the rearranged image information in step S126.

FIG. 12 shows a third display example of the image information resulting from the detection.

As a result of the processing (shown in FIG. 11) for determining the order for displaying the image information of the search result, similar images are sequentially displayed, so that the user can easily find desired image information.

A description will now be given of another scheme for the feature detection processing executed by the controller 21 in step S103. Text information 173 that is not intended by the user may be contained in the image database 17. For example, as in the image information 171 with the image file name P003 shown in FIG. 3, text information 173 that contains the keyword “Mt. Fuji” may be affixed to image information that does not show an image of Mt. Fuji. In the entire image database 17, the number of data records in which the image information 171 and the text information 173 are associated with other in spite of the fact that they are unrelated to each other is small, so that image information that is adequate relative to the search query word information is detected in many cases. In such a situation, the controller 21 classifies the features (obtained in step S103) of the image information, detected by the search processing using the search query word information, into multiple categories. This is because, in general, categories into which many pieces of image information are classified are, in many cases, image information that is highly likely to be associated with search query word information.

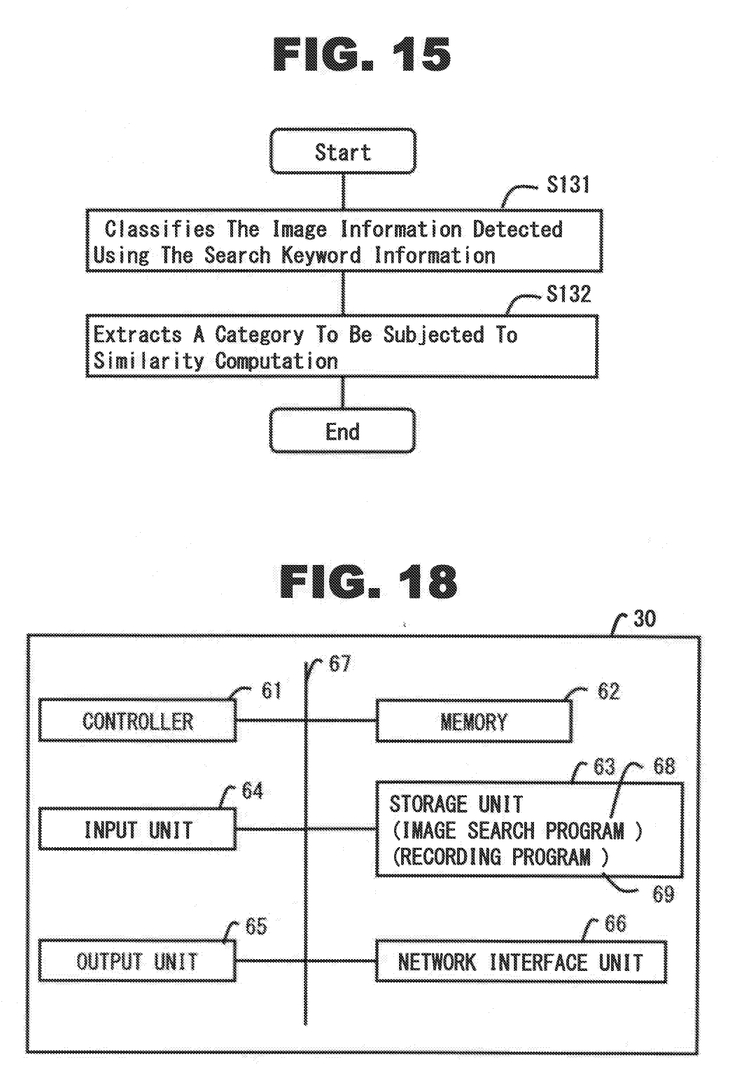

FIG. 15 is a flowchart of another scheme for the feature detection processing executed by the controller 21 in step S103.

In step S131, the controller 21 classifies the image information detected using the search query word information in step S102 into categories. The image information 171 detected by the controller 21 in the keyword-search processing in step S102 is the image information 171 with the image file names P001, P003, and P006. Thus, the controller 21 classifies the image information 171 with the image file names P001, P003, and P006 into categories. Since the number of images in the aspect of the embodiment is small, the image information 171 is classified into two categories. The category classification method may be a known classification method. Examples of a known classification method include a K-means method, a self-organizing map method, and an OPTICS method.

When the controller 21 executes the processing for classifying three pieces of image information 171 with the image file names P001, P003, and P006 into categories, for example, the image information 171 with the image file names P001 and P006 is classified into a category C1 and the image information 171 with the image file name P003 is classified into a category C2.

In step S132, the controller 21 extracts a category to be subjected to similarity computation. More specifically, a threshold for determining whether or not a category is to be used for the similarity computation is preset. In the aspect of the embodiment, the threshold is set to two or more pieces of image information included in a category. Thus, the controller 21 determines the category C1 that meets the threshold as a category to be subjected to the similarity computation.

The similarities between two pieces of image information 171 with the image file names P001 and P006 contained in the category C1 and the image information 171 with the image file names P002, P004, and P005 have the following values. The similarity between the image information 171 with the image file name P001 and the image information 171 with the image file name P002 is 1.7 and the similarity between the image information 171 with the image file name P006 and the image information 171 with the image file name P002 is 1.7. Thus, the average value of the similarities is 1.7. The similarity between the image information 171 with the image file name P001 and the image information 171 with the image file name P004 is 5.2 and the similarity between the image information 171 with the image file name P006 and the image information 171 with the image file name P004 is 5.4. Thus, the average value of the similarities is 5.3. The similarity between the image information 171 with the image file name P001 and the image information 171 with the image file name P005 is 3.0 and the similarity between the image information 171 with the image file name P006 and the image information 171 with the image file name P005 is 3.3. Thus, the average value of the similarities is 3.2.

Consequently, the similarity average value for the image information 171 with the image file name P002 is the smallest, so that the controller 21 determines that the image information 171 with the image file name P002 is similar to the images “Mt. Fuji” in the category C1.

Execution of the above-described processing makes it possible to prevent the controller 21 from detecting image information in which text information 173 and image information 171 are not associated with each other, such as the image information 171 with the image file name P003 shown in FIG. 3. As a result, the controller 21 can output high-accuracy similar images excluding exceptional image information.

Provision of an area for storing once-calculated features in association with each data record also makes it possible to reduce a time that the controller 21 requires for performing a next feature computation.

A description will now be given of a case using a first database to be searched using search query word information and a second database to be searched for similar images.

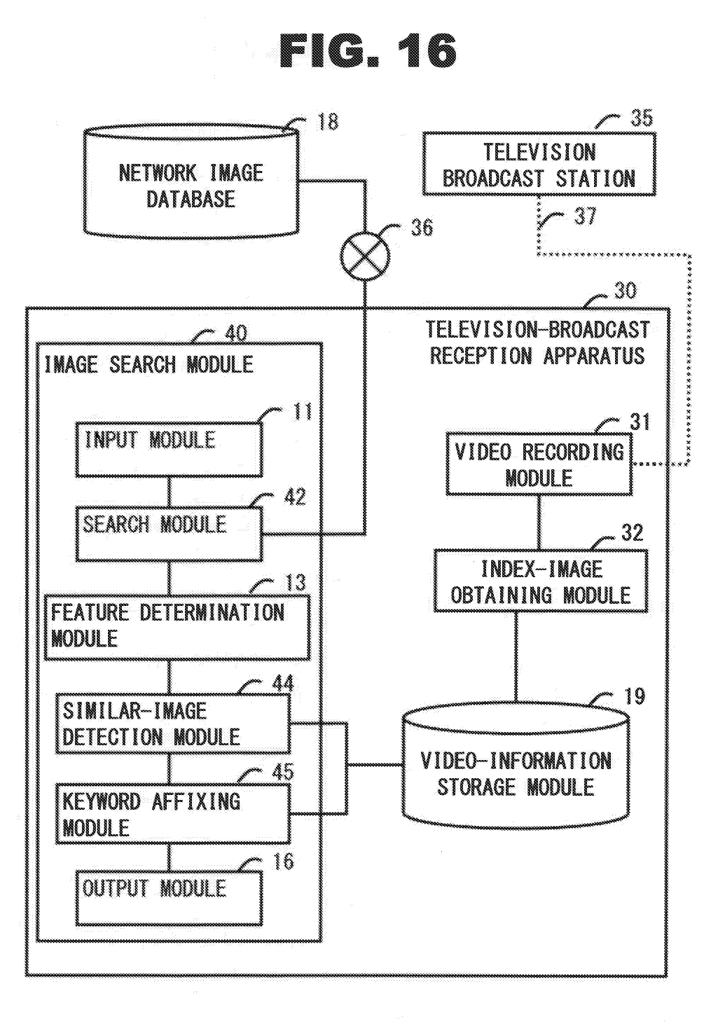

FIG. 16 is a block diagram showing an example of the configuration of a system that includes multiple databases. In FIG. 16, a television broadcast station 35 broadcasts image information. A television-broadcast reception apparatus 30 in this system uses a recording function to record the video information from the television broadcast station 35, and generates index image data for each specific segment (scene) of the recorded video. An image search module 40 searches for a desired scene corresponding to input search query word information and outputs the found scene.

In the system shown in FIG. 16, the image search module 40 and a network image database 18 are interconnected through a network 36. The network 36 is, for example, the Internet or a LAN. The television broadcast station 35 and the television-broadcast reception apparatus 30 perform video broadcast and video reception, respectively, for example, over radio waves 37. The video broadcast and video reception can be performed not only over the radio waves 37 but also over cable broadcast or through a network. A connection for such the arrangement may be changed as needed. For example, the arrangement may be such that the image search module 40 and the television-broadcast reception apparatus 30 are separated from each other and are electrically connected with each other. When the image search module 40 and the television-broadcast reception apparatus 30 are separated from each other, the image search module 40 and the television-broadcast reception apparatus 30 are interconnected through, for example, a USB or a network.

The network image database 18 is a database that stores, out of the image database 17, data records in which the text information 173 and the image information 171 are associated with each other. The data structure of the network image database 18 is analogous to the data structure of the image database 17 shown in FIG. 3.

For example, a typical internet image search system can be used for the network image database 18. A search module 42 executes a web service for performing image search processing with search query word information. The search module 42 acquires image information obtained from a result of the search of the web service, the image information having text information corresponding to the search query word information.

The television broadcast station 35 is, for example, a wireless broadcast station, a cable broadcast station, or a network-based video-information distribution station.

The television-broadcast reception apparatus 30 receives the video information from the television broadcast station 35 over, for example, the radio waves 37. The radio waves 37 are used in the aspect of the embodiment to provide typical wireless broadcast or cable broadcast, for simplicity of description; however, a scheme for distributing video information through communication using the network 36 may also be used.

The television-broadcast reception apparatus 30 has a video recording module 31, an index-image obtaining module 32, and a video-information storage module 19. The video recording module 31 receives the video information from the television broadcast station 35. When the received video information is analog information, the video recording module 31 digitizes the received video information by encoding it based on Moving Picture Experts Group (MPEG) 2 or the like. For recording video information, the video recording module 31 detects breaks of video information, breaks of sound, and so on to divide the video information into multiple video segments. The video recording module 31 stores the divided video segments in the video-information storage module 19.

The index-image obtaining module 32 extracts, as an index image, an image that serves as the front-end frame of the video segments divided by the video recording module 31. The index-image obtaining module 32 associates the information of the extracted index image and the video segments and stores the associated information and video segments in the video-information storage module 19.

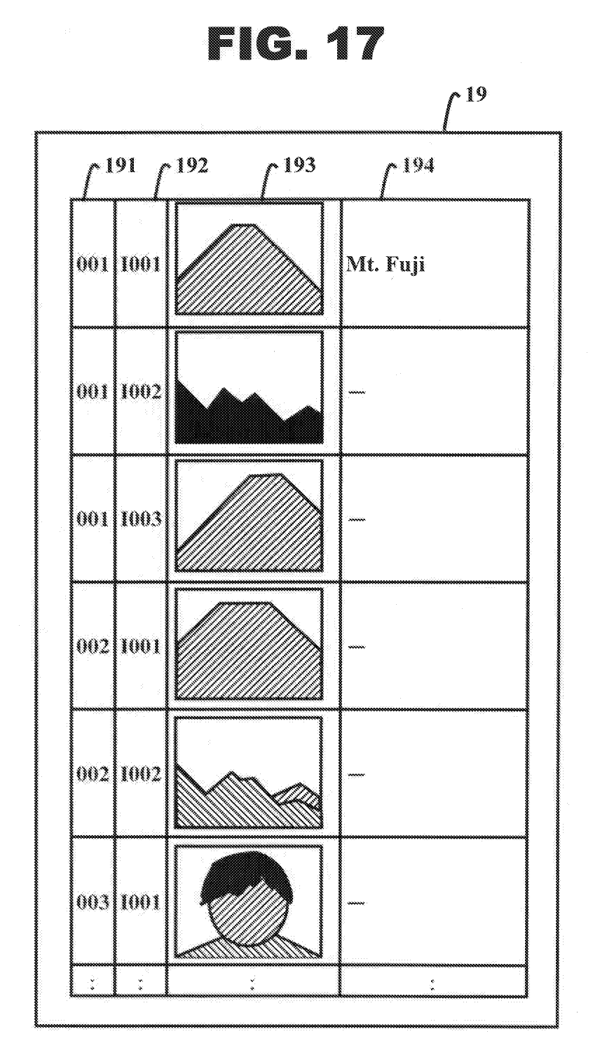

The video-information storage module 19 stores video information. The video-information storage module 19 corresponds to a hard disk drive for storing a list of video segments (scenes) generated from recorded video information. FIG. 17 shows an example of the structure of data stored in the video-information storage module 19. Data records stored in the video-information storage module 19 are constituted by video-information identification numbers 191, video-segment identification numbers 192, index image information 193, and text information 194.

The image search module 40 has an input module 11, the search module 42, a feature determination module 13, a similar-image detection module 44, a keyword affixing module 45, and an output module 16.

The image search module 40 shown in FIG. 16 is different from the image search apparatus 10 shown in FIG. 1 in that the image search module 40 lacks the image database 17 included in the image search apparatus 10. The system shown in FIG. 16 has two sections that are alternative to the image database 17 included in the image search apparatus 10, namely, the network image database 18 and the image-information storage module 19.

The search module 42 in the image search module 40 obtains, through the network 36, data records that are stored in the network image data 18 and that have text information 173 that matches the search query word information input to the input module 11.

The similar-image detection module 44 determines a similarity between index image information 193 stored in the image-information storage module 19 and image information 171 stored in the network image database 18.

The keyword affixing module 45 affixes the search query word information to the text information 194 of the data records containing the index image information 193 determined as image information similar to the search query word information.

Since the operations of the input module 11, the feature determination module 13, and the output module 16 in the image search module 40 are analogous to the operations of those in the image search apparatus 10, the descriptions thereof are not given hereinafter.

FIG. 18 is a block diagram showing an example of a hardware configuration for the system shown in FIG. 16. The television-broadcast reception apparatus 30 includes a controller 61, a memory 62, a storage unit 63, an input unit 64, an output unit 65, and a network interface unit 66, which are connected to a bus 67.

The controller 61 controls the entire television-broadcast reception apparatus 30 and is, for example, a central processing unit (CPU). The controller 61 executes an image search program 68 and a recording program 69 loaded in the memory 62. The image search program 68 causes the controller 61 to function as the input module 11, the search module 42, the feature determination module 13, the similar-image detection module 44, the keyword affixing module 45, and the output module 16 in the image search module 40. The recording program 69 causes the controller 61 to function as the video recording module 31 and the index-image obtaining module 32.

The memory 62 is a storage area into which the image search program 68 and the recording program 69 stored in the storage unit 63 are to be loaded. The memory 62 is a storage area in which various computation results generated while the controller 61 executes the image search program 68 and the recording program 69. The memory 62 is, for example, a random access memory (RAM). The input unit 64 receives the search query word information from the user. The input unit 64 includes, for example, a keyboard, a mouse, and a touch panel. The output unit 65 outputs a search result of image information. The output unit 65 includes, for example, a display (display device). The storage unit 63 stores the image search program 68, the recording program 69, and the video-information storage module 19. The storage unit 63 includes, for example, a hard disk device.

The network interface unit 66 is connected to a network, such as the Internet or a local area network (LAN), to allow data to be transmitted/received through the network. Thus, the television-broadcast reception apparatus 30 may be connected to another apparatus having an input unit, an output unit, a memory, and a storage unit, via the network interface unit 66. The television-broadcast reception apparatus 30 can also download, for example, the image search program 68, the recording program 69, and/or the video-information storage module 19 received via the network interface unit 66 or recorded on a storage medium.

A description will now be given of processing executed by the television-broadcast reception apparatus 30.

Initially, the data records stored in the video information storage module 19 do not have any text information 194. The user enters search query word information to the television-broadcast reception apparatus 30. The input module 11 receives the search query word information. Using the received search query word information, the search module 42 executes processing for searching for text information 173 in the network image database 18. The search module 42 obtains, as a search result, image information 171 having matched text information 173 in the network image database 18. The feature determination module 13 determines features of each piece of the obtained image information 171 in the network image database 18.

The similar-image detection module 44 then reads the index image information 193 stored in the video-information storage module 19 in the television-broadcast reception apparatus 30. The similar-image detection module 44 determines the similarities of individual pieces of index image information 193, based on the image information 171 in the network image database 18 and the index image information 193 in the video-information storage module 19. In accordance with the similarities, the similar-image detection module 44 determines index image information 193 as a similar image or similar images.

The keyword affixing module 45 stores the search query word information in the text information 194 in association with the index image information 193 determined as the similar image(s). The output module 16 outputs, on the screen, the index image information 193 determined as the similar image(s). As required, the user can select the index image information 193, determined as the similar image(s), on the screen to view desired video. With the arrangement described above, by search using a keyword, the user can view even video information with which no keyword information is associated.

Although the aspect of the embodiment has been described above in detail, the aspect of the embodiment is not limited to the particular the aspect of the embodiment described above. Needless to say, various modifications and changes may be made to the aspect of the embodiment without departing from the spirit and scope of the aspect of the embodiment.

What is claimed is:

1. A method for searching a set of image data from a database which contains a plurality of sets of image data, at least one of the sets of the image data being associated with text data, the method comprising the steps of:
obtaining keyword information;
detecting first set of image data in said database associated with text data corresponding to said keyword information; and
detecting second set of image data in said database on the basis of the feature of an image represented by said first set of image data.

2. The method according to claim 1, wherein the step of detecting second set of image data comprises a step of determining similarity.

3. The method according to claim 1, further comprising, calculating a value of said feature of said set of image data in said database,
wherein the step of detecting second set of image data comprises a step of determining similarity between said feature of said first set of image data and the feature of said second set of image data.

4. The method according to claim 1, further comprising,
storing said keyword information in said database as text data corresponding to said second set of image data.

5. The method according to claim 1, further comprising,
sorting said second set of image data when the step of detecting said second set of image data detects two or more said second set of image data according to the strength of the correlation, and outputting the sorted images.

6. The method according to claim 4, further comprising,
displaying said second set of image data with text data.

7. An apparatus searching a set of image data, comprising:
a database for storing a plurality of sets of image data, at least one of the sets of the image data being associated with text data;
an obtaining module obtaining keyword information;
a search module for detecting first set of image data in said database associated with text data corresponding to said keyword information; and
a detection module for detecting second set of image data in said database on the basis of the feature of an image represented by said first set of image data.

8. The apparatus according to claim 7, wherein said detection module detects second set of image data comprises a step of determining correlation.

9. The apparatus according to claim 7, further comprising, a determination module for calculating a value of said feature of said set of image data in said database,
wherein said detection module determines correlation between said feature of said first set of image data and the feature of said second set of image data.

10. The apparatus according to claim 7, further comprising,
storing module for storing said keyword information in said database as text data corresponding to said second set of image data.

11. The apparatus according to claim 7, further comprising,
outputting module for sorting said second set of image data when the step of detecting said second set of image data detects two or more said second set of image data according to the strength of the correlation, and outputting the sorted images.

12. The apparatus according to claim 11, wherein said outputting module displays said second set of image data with text data.

13. A computer readable medium storing a program for controlling an apparatus for searching a set of image data, comprising a database for storing a plurality of sets of image data, at least one of the sets of the image data being associated with text data, according to a process comprising;
obtaining keyword information;
detecting first set of image data in said database associated with text data corresponding to said keyword information; and
detecting second set of image data in said database on the basis of the feature of an image represented by said first set of image data.
